(19) United States
(12) Patent Application Publication
(10) Pub. No.: US 2022/0107634 A1
(43) Pub. Date: Apr. 7, 2022

(54) VEHICLE SELF-DRIVING SYSTEM, OPERATION METHOD FOR VEHICLE SELF-DRIVING SYSTEM, AND STORAGE MEDIUM

(71) Applicant: TOYOTA JIDOSHA KABUSHIKI KAISHA, Aichi-ken (JP)

(72) Inventors: Takahiro OKANO, Chiryu-shi (JP); Takaaki YANAGIHASHI, Toyota-shi (JP); Hiroaki KIYOKAMI, Nisshin-shi (JP); Toru TAKASHIMA, Susono-shi (JP); Kenta MIYAHARA, Okazaki-shi (JP); Yohei TANIGAWA, Toyota-shi (JP)

(21) Appl. No.: 17/492,678

(22) Filed: Oct. 4, 2021

(30) Foreign Application Priority Data
Oct. 7, 2020 (JP) 2020-170107

(51) Int. Cl. G05D 1/00; G05D 1/02

(52) U.S. Cl. CPC G05D 1/0022; G05D 1/0027; G05D 2201/0213; G05D 1/0223; G05D 1/0061

(57) ABSTRACT

A vehicle self-driving system includes: a communication section provided separately from an unmanned self-driving vehicle configured to travel unmanned within a predefined area and a manned driven vehicle that has entered the predefined area and has completed a handover of driving authority, the communication section being configured to perform two-way wireless communication with the unmanned self-driving vehicle and the manned driven vehicle; and a control section configured to be handed driving authority from the manned driven vehicle by the wireless communication and to control respective movements of the unmanned self-driving vehicle and the manned driven vehicle based on the wireless communication, and further configured to effect control such that a communication cycle of the wireless communication with at least one of the unmanned self-driving vehicle or the manned driven vehicle is lengthened in cases in which a communication traffic volume of the wireless communication has exceeded a predefined value.

### CROSS-REFERENCE TO RELATED APPLICATION

This application is based on and claims priority under 35 USC 119 from Japanese Patent Application No. 2020-170107 filed on Oct. 7, 2020, the disclosure of which is incorporated by reference herein.

### BACKGROUND

### Technical Field

The present disclosure relates to a vehicle self-driving system, an operation method for a vehicle self-driving system, and a storage medium stored with a control program.

### Related Art

Japanese Patent Application Laid-Open (JP-A) No. 2020-35055 discloses an unmanned vehicle control device that controls an unmanned vehicle traveling unmanned within a predefined site. In this unmanned vehicle control device, a position of a manned vehicle undergoing manned travel along a predefined travel route within the predefined site is detected by a manned vehicle detection section. An unmanned vehicle control section controls the unmanned vehicle so as to travel by avoiding a predefined range from the position of the manned vehicle on the travel route as detected by the manned vehicle detection section. In this unmanned vehicle control device, the unmanned vehicle is controlled so as to travel by avoiding the predefined range from the position of the manned vehicle on the travel route of the manned vehicle as detected by the manned vehicle detection section, thereby enabling a reduction in collisions between the unmanned vehicle and the manned vehicle.

In a predefined area such as a factory facility, manned vehicles may also be controlled by a vehicle travel system taking overall control within the predefined area. In such a vehicle travel system, large numbers of manned driven vehicles and unmanned self-driving vehicles within the predefined area may place an excessive burden on wireless communication between the system-side and the manned driven vehicles and unmanned self-driving vehicles.

### SUMMARY

In consideration of the above circumstances, the present disclosure provides a vehicle self-driving system capable of suppressing an excessive burden from being placed on wireless communication between a system-side and manned driven vehicles and unmanned self-driving vehicles, an operation method for such a vehicle self-driving system, and storage medium for such a control program.

A first aspect of the present disclosure is a vehicle self-driving system including a communication section provided separately from both an unmanned self-driving vehicle configured to travel unmanned within a predefined area and a manned driven vehicle that has entered the predefined area and has completed a handover of driving authority, the communication section being configured to perform two-way wireless communication with both the unmanned self-driving vehicle and the manned driven vehicle; and a control section configured to be handed driving authority from the manned driven vehicle by the wireless communication and to control respective movements of the unmanned self-driving vehicle and the manned driven vehicle based on the wireless communication, and further configured to effect control such that a communication cycle of the wireless communication with at least one of the unmanned self-driving vehicle or the manned driven vehicle is lengthened in a case in which a communication traffic volume of the wireless communication has exceeded a predefined value.

In the vehicle self-driving system of the first aspect, one or more unmanned self-driving vehicles and one or more manned driven vehicles travel within the predefined area. Wireless communication is enabled between the unmanned self-driving vehicle and the communication section of the vehicle self-driving system. The control section of the vehicle self-driving system controls movement of the unmanned self-driving vehicle based on this wireless communication between the unmanned self-driving vehicle and the communication section.

Wireless communication is also enabled between the manned driven vehicle and the communication section of the vehicle self-driving system. When the manned driven vehicle enters the predefined area and driving authority is handed over to the control section of the vehicle self-driving system via the communication section of the vehicle self-driving system by the wireless communication, the control section of the vehicle self-driving system controls movement of the manned driven vehicle based on the wireless communication between the communication section and at least one of the unmanned self-driving vehicle or the manned driven vehicle.

Note that in cases in which the communication traffic volume of the wireless communication between the communication section and the unmanned self-driving vehicle and the manned driven vehicle exceeds the predefined value, the control section performs control to lengthen the communication cycle of the wireless communication with at least one vehicle of the unmanned self-driving vehicle or the manned driven vehicle. Lengthening the communication cycle of the wireless communication with at least one of the vehicles in this manner enables a commensurate re-allocation to wireless communication with an additional unmanned self-driving vehicle, thereby enabling the wireless communication to be secured with the unmanned self-driving vehicle.

In this manner, in the vehicle self-driving system of the first aspect, the commensurate re-allocation to wireless communication with an additional unmanned self-driving vehicle enabled by lengthening the communication cycle of wireless communication with the at least one vehicle of the unmanned self-driving vehicle and the manned driven vehicle enables the wireless communication to be secured with the unmanned self-driving vehicle, and enables an excessive burden on the wireless communication to be suppressed from occurring.

A second aspect of the present disclosure is a vehicle self-driving system including a communication section provided separately from both an unmanned self-driving vehicle configured to travel unmanned within a predefined area and a manned driven vehicle that has entered the predefined area and has completed a handover of driving authority, the communication section being configured to perform two-way wireless communication with both the unmanned self-driving vehicle and the manned driven vehicle; and a control section configured to be handed driving authority from the manned driven vehicle by the wireless communication and to control respective movements of the unmanned self-driving vehicle and the manned driven vehicle based on the wireless communication, and further configured to interrupt the wireless communication with the manned driven vehicle in a case in which a communication traffic volume of the wireless communication has exceeded a predefined value.

In the vehicle self-driving system of the second aspect, one or more unmanned self-driving vehicles and one or more manned driven vehicles travel within the predefined area. Wireless communication is enabled between the unmanned self-driving vehicle and the communication section of the vehicle self-driving system. The control section of the vehicle self-driving system controls movement of the unmanned self-driving vehicle based on the wireless communication between the unmanned self-driving vehicle and the communication section.

Wireless communication is also enabled between the manned driven vehicle and the communication section of the vehicle self-driving system. When the manned driven vehicle enters the predefined area and hands over driving authority to the control section of the vehicle self-driving system by wireless communication via the communication section of the vehicle self-driving system, the control section of the vehicle self-driving system controls movement of the manned driven vehicle based on the wireless communication between the manned driven vehicle and the communication section.

Note that in cases in which the communication traffic volume of the wireless communication between the communication section and the unmanned self-driving vehicle and the manned driven vehicle exceeds the predefined value, the wireless communication with the manned driven vehicle is interrupted (i.e., cut off) by the control section. Interrupting the wireless communication of the communication section with the manned driven vehicle enables wireless communication traffic volume to be freed up for re-allocation to the wireless communication with the unmanned self-driving vehicle, thereby enabling the wireless communication to be secured with the unmanned self-driving vehicle.

In the vehicle self-driving system of the second aspect, the interrupting the wireless communication of the communication section with the manned driven vehicle enables wireless communication traffic volume to be freed up for re-allocation to wireless communication with the unmanned self-driving vehicle, thereby enabling the wireless communication to be secured with the unmanned self-driving vehicle, and enabling an excessive burden on the wireless communication to be suppressed from occurring.

A third aspect of the present disclosure is a vehicle self-driving system including a communication section provided separately from both an unmanned self-driving vehicle configured to travel unmanned within a predefined area and a manned driven vehicle that has entered the predefined area and has completed a handover of driving authority, the communication section being configured to perform two-way wireless communication with both the unmanned self-driving vehicle and the manned driven vehicle; and a control section configured to be handed driving authority from the manned driven vehicle by the wireless communication and to control respective movements of the unmanned self-driving vehicle and the manned driven vehicle based on the wireless communication, and further configured to reduce a volume of information received via the wireless communication of at least one of the unmanned self-driving vehicle or the manned driven vehicle in a case in which a communication traffic volume of the wireless communication has exceeded a predefined value.

In the vehicle self-driving system of the third aspect, one or more unmanned self-driving vehicles and one or more manned driven vehicles travel within the predefined area. Wireless communication is enabled between the unmanned self-driving vehicle and the communication section of the vehicle self-driving system. The control section of the vehicle self-driving system controls movement of the unmanned self-driving vehicle based on the wireless communication between the unmanned self-driving vehicle and the communication section.

Wireless communication is also enabled between the manned driven vehicle and the communication section of the vehicle self-driving system. When the manned driven vehicle enters the predefined area and hands over driving authority to the control section of the vehicle self-driving system by wireless communication via the communication section of the vehicle self-driving system, the control section of the vehicle self-driving system controls movement of the manned driven vehicle based on the wireless communication between the manned driven vehicle and the communication section.

Note that in cases in which the communication traffic volume of the wireless communication between the communication section and the unmanned self-driving vehicle and the manned driven vehicle exceeds the predefined value, the control section reduces a volume of received information in the wireless communication of at least one vehicle of the unmanned self-driving vehicle or the manned driven vehicle. Reducing the volume of received information in the wireless communication of at least one vehicle in this manner enables wireless communication to be introduced for an additional vehicle, thereby enabling the wireless communication to be secured with at least one vehicle of the unmanned self-driving vehicle or the manned driven vehicle.

The vehicle self-driving system of the third aspect is capable of securing the wireless communication with at least one vehicle of the unmanned self-driving vehicles and the manned driven vehicle, thereby enabling an excessive burden on the wireless communication to be suppressed from occurring.

In the vehicle self-driving system according to the first aspect to the third aspect, a configuration may be adopted in which the control section controls so as to lower a travel speed of at least one vehicle of the manned driven vehicle or the unmanned self-driving vehicle in cases in which a communication traffic volume of the wireless communication has exceeded a predefined value.

In the above configuration, the travel speed of at least one vehicle of the manned driven vehicle or the unmanned self-driving vehicle is lowered in cases in which a communication traffic volume of the wireless communication has exceeded a predefined value. This improves safety for both the manned driven vehicle and the unmanned self-driving vehicles.

A fourth aspect of the present disclosure is an operation method for a vehicle self-driving system including an unmanned self-driving vehicle configured to travel unmanned within a predefined area, a manned driven vehicle that has entered the predefined area and has handed over driving authority, and a communication section configured to perform two-way wireless communication with both the unmanned self-driving vehicle and the manned driven vehicle, the operation method including: controlling respective movements of the unmanned self-driving vehicle and the manned driven vehicle based on the wireless communication after the driving authority has been handed over from the manned driven vehicle to the system by the wireless communication; and in a case in which a communication traffic volume of the wireless communication has exceeded a predefined value, performing at least one of: (a) effecting control so as to lengthen a communication cycle of the wireless communication with at least one of the unmanned self-driving vehicle or the manned driven vehicle, or (b) interrupting the wireless communication with the manned driven vehicle.

A fifth aspect of the present disclosure is an operation method for a vehicle self-driving system including an unmanned self-driving vehicle configured to travel unmanned within a predefined area, a manned driven vehicle that has entered the predefined area and has handed over driving authority, and a communication section configured to perform two-way wireless communication with both the unmanned self-driving vehicle and the manned driven vehicle, the operation method including: controlling respective movements of the unmanned self-driving vehicle and the manned driven vehicle based on the wireless communication after the driving authority has been handed over from the manned driven vehicle to the system by the wireless communication; and reducing a volume of information received via the wireless communication of at least one of the unmanned self-driving vehicle or the manned driven vehicle in a case in which a communication traffic volume of the wireless communication has exceeded a predefined value.

A sixth aspect of the present disclosure is a non-transitory storage medium storing a program executable by a computer to perform control processing for a vehicle self-driving system including an unmanned self-driving vehicle configured to travel unmanned within a predefined area, a manned driven vehicle that has entered the predefined area and has handed over driving authority, and a communication section configured to perform two-way wireless communication with both the unmanned self-driving vehicle and the manned driven vehicle, the control processing including: controlling respective movements of the unmanned self-driving vehicle and the manned driven vehicle based on the wireless communication after the driving authority has been handed over from the manned driven vehicle to the system by the wireless communication; and in a case in which a communication traffic volume of the wireless communication has exceeded a predefined value, performing at least one of: (a) effecting control so as to lengthen a communication cycle of the wireless communication with at least one of the unmanned self-driving vehicle or the manned driven vehicle, or (b) interrupting the wireless communication with the manned driven vehicle.

A seventh aspect of the present disclosure is a non-transitory storage medium storing a program executable by a computer to perform control processing for a vehicle self-driving system including an unmanned self-driving vehicle configured to travel unmanned within a predefined area, a manned driven vehicle that has entered the predefined area and has handed over driving authority, and a communication section configured to perform two-way wireless communication with both the unmanned self-driving vehicle and the manned driven vehicle, the control processing including: controlling respective movements of the unmanned self-driving vehicle and the manned driven vehicle based on the wireless communication after the driving authority has been handed over from the manned driven vehicle to the system by the wireless communication; and reducing a volume of information received via the wireless communication of at least one of the unmanned self-driving vehicle or the manned driven vehicle in a case in which a communication traffic volume of the wireless communication has exceeded a predefined value.

The fourth aspect to the seventh aspect are also capable of securing wireless communication with the unmanned self-driving vehicle and suppressing an excessive burden from being placed on the wireless communication.

### BRIEF DESCRIPTION OF THE DRAWINGS

FIG. 1 is a block diagram illustrating a hardware configuration of a vehicle self-driving system according to a first exemplary embodiment.

FIG. 2 is a flowchart for a vehicle self-driving program of a vehicle self-driving system according to the first exemplary embodiment.

FIG. 3 is a flowchart for a vehicle self-driving program of a vehicle self-driving system according to a second exemplary embodiment.

### DETAILED DESCRIPTION

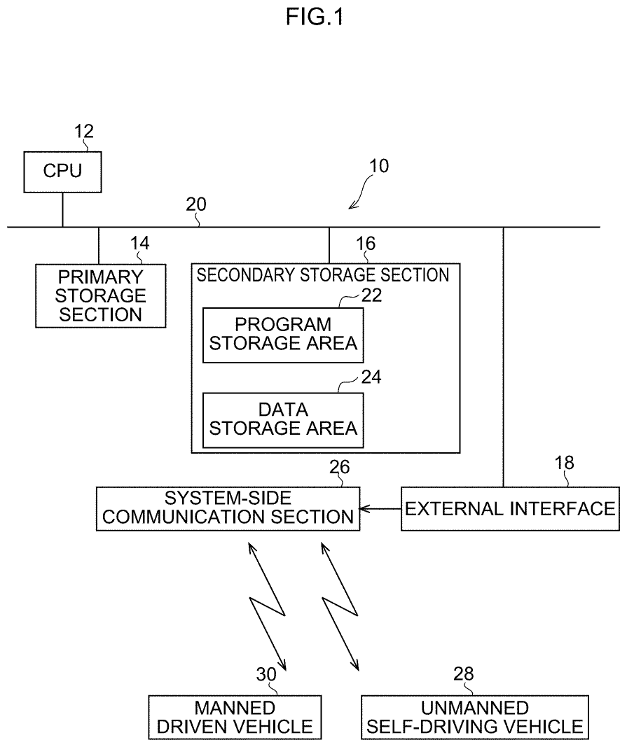

Explanation follows regarding exemplary embodiments of the present disclosure, with reference to FIG. 1 to FIG. 3.

### Configuration of First Exemplary Embodiment

FIG. 1 illustrates an example of a hardware configuration of a vehicle self-driving system 10. As illustrated in FIG. 1, hardware of the vehicle self-driving system 10 includes a central processing unit (CPU) 12 serving as a control section and an example of a processor, a primary storage section 14, a secondary storage section 16, and an external interface 18. The CPU 12, the primary storage section 14, the secondary storage section 16, and the external interface 18 are connected together through a bus 20. The CPU 12, the primary storage section 14, the secondary storage section 16, and the external interface 18 may be included in an engine control unit (ECU).

The primary storage section 14 is configured by volatile memory such as random access memory (RAM). The secondary storage section 16 is configured by non-volatile memory such as read only memory (ROM), a hard disk drive (HDD), or a solid state drive (SSD). The secondary storage section 16 includes a program storage area 22 and a data storage area 24. As an example, a program such as a vehicle self-driving program for causing the CPU 12 to execute vehicle self-driving processing is stored in the program storage area 22. Data such as temporary intermediate data generated during the vehicle self-driving processing is stored in the data storage area 24.

The CPU 12 reads the vehicle self-driving program from the program storage area 22, loads the program to the primary storage section 14, and executes the program. Note that the program, for example the vehicle self-driving program, may be stored on a non-volatile recording medium such as a digital versatile disc (DVD), read using a reader for the recording medium, and expanded in the primary storage section 14.

A system-side communication section 26, serving as a communication section, is electrically connected to the external interface 18. The system-side communication section 26 is capable of communicating with an unmanned self-driving vehicle-side communication section of a self-driving unit (none of which are illustrated in the drawings) of unmanned self-driving vehicles 28 that travel within a predefined area, for example within a factory site. The self-driving unit of the unmanned self-driving vehicle 28 includes an acceleration device, a brake device, and a steering device. The acceleration device, brake device, and steering device are connected to a CPU. The acceleration device performs acceleration operations, the braking device performs braking operations, and the steering device performs steering operations based on electrical signals from the CPU.

The self-driving unit of the unmanned self-driving vehicle 28 is connected to a global positioning system (GPS) device (not illustrated in the drawings). The unmanned self-driving vehicle 28 is capable of obtaining a current location and a destination based on information from the GPS device. The self-driving unit of the unmanned self-driving vehicle 28 is also connected to an imaging device (not illustrated in the drawings). The imaging device is capable of capturing images of the surroundings of the unmanned self-driving vehicle 28 and recognizing obstacles and the like in the direction of progress of the unmanned self-driving vehicle 28.

Information from the acceleration device, brake device, steering device, GPS device, imaging device, and so on is converted to wireless communication signals and sent from the unmanned self-driving vehicle-side communication section in the self-driving unit of the unmanned self-driving vehicle 28 to the system-side communication section 26. Moreover, wireless communication signals sent from the system-side communication section 26 to the unmanned self-driving vehicle-side communication section in the self-driving unit of the unmanned self-driving vehicle 28 are converted to signals for the acceleration device, brake device, steering device, GPS device, imaging device, and so on.

The system-side communication section 26 is also capable of communicating with a manned driven vehicle-side communication section of a self-driving unit (none of which are illustrated in the drawings) of manned driven vehicles 30 arriving at an entrance to the predefined area. Each of the manned driven vehicles 30 has basically the same self-driving unit as the self-driving unit of the unmanned self-driving vehicle 28. Similarly, the manned driven vehicle-side communication section in the self-driving unit of the manned driven vehicle 30 is capable of communicating with the system-side communication section 26 when the manned driven vehicle 30 arrives at the entrance to the predefined area. After the manned driven vehicle-side communication section in the self-driving unit of the manned driven vehicle 30 hands over driving authority to the system-side communication section 26, the manned driven vehicle 30 is controlled by the vehicle self-driving system 10 in a similar manner to the unmanned self-driving vehicle 28.

### Operation and Effects of First Exemplary Embodiment

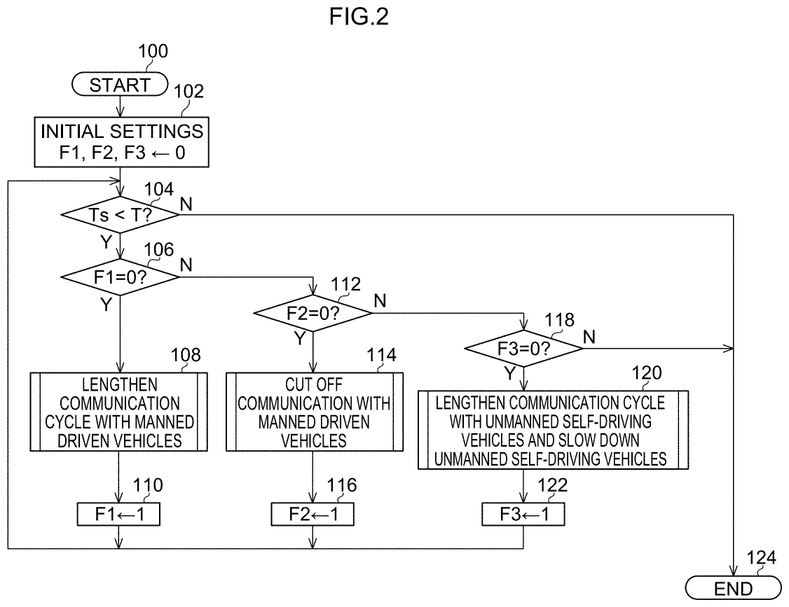

Next, explanation follows regarding operation and effects of the first exemplary embodiment, with reference to the flowchart for the vehicle self-driving program illustrated in FIG. 2.

At step 100, the vehicle self-driving program starts. At step 102, initial settings are performed so as to assign 0 to respective flags F1, F2, and F3. Next, at step 104, determination is made as to whether or not a communication traffic volume T of wireless communication output from the CPU 12 to all unmanned self-driving vehicles 28 and to all manned driven vehicles 30 that have handed over driving authority to the vehicle self-driving system 10 has exceeded a predetermined and predefined communication traffic volume Ts. Processing proceeds to step 106 in cases in which determination is made at step 104 that the wireless communication traffic volume T has exceeded the predetermined and predefined communication traffic volume Ts, and determination is made at step 106 as to whether or not 0 has been assigned to the flag F1.

Processing proceeds to step 108 in cases in which determination is made at step 106 that 0 has been assigned to the flag F1, and processing is performed at step 108 to lengthen a communication cycle of the wireless communication with the manned driven vehicles 30. Lengthening the communication cycle of the wireless communication with the manned driven vehicles 30 at step 108 enables a commensurate re-allocation to wireless communication with an additional unmanned self-driving vehicle 28, thereby enabling the wireless communication to be secured with the unmanned self-driving vehicle 28. After processing to lengthen the communication cycle of the wireless communication with the manned driven vehicles 30 has been performed at step 108, 1 is assigned to the flag F1 at the next step 110, and processing returns to step 104.

Processing proceeds to step 112 in cases in which determination is made at step 106 that 1 is assigned to the flag F1, namely in cases in which the processing of step 108 to lengthen the communication cycle of the wireless communication with the manned driven vehicles 30 has already been performed, and determination is made at step 112 as to whether or not 0 has been assigned to the flag F2. Processing proceeds to step 114 in cases in which determination is made at step 112 that 0 has been assigned to the flag F2, and processing is performed at step 114 to interrupt (i.e., cut off) wireless communication with the manned driven vehicles 30.

Performing this processing to interrupt wireless communication with the manned driven vehicles 30 at step 114 enables a wireless communication traffic volume commensurate to the volume of wireless communication traffic with the manned driven vehicles 30 to be freed up and enables its re-allocation to wireless communication with the unmanned self-driving vehicles 28. This enables the wireless communication to be secured with the unmanned self-driving vehicles 28. After the processing of step 114 to interrupt wireless communication with the manned driven vehicles 30 has been performed, 1 is assigned to the flag F2 at the next step 116, and processing returns to step 104.

On the other hand, processing proceeds to step 118 in cases in which determination is made at step 112 that 1 has been assigned to the flag F2, namely in cases in which processing to interrupt wireless communication with the manned driven vehicles 30 has already been performed at step 114, and determination is made at step 118 as to whether or not 0 has been assigned to the flag F3. Processing proceeds to step 120 in cases in which determination is made at step 118 that 0 has been assigned to the flag F3. Processing is performed at step 120 to lengthen a communication cycle of the wireless communication with the unmanned self-driving vehicles 28 and also to lower a travel speed of the unmanned self-driving vehicles 28.

Performing processing to lengthen the communication cycle of the wireless communication with the unmanned self-driving vehicles 28 at step 120 enables a commensurate re-allocation to wireless communication with an additional unmanned self-driving vehicle 28, enabling the wireless communication to be secured with the unmanned self-driving vehicle 28. Since the communication cycle of the wireless communication with the unmanned self-driving vehicles 28 is lengthened in this manner, the time interval is lengthened until wireless communication is next performed with the unmanned self-driving vehicle 28. Accordingly, processing is performed at step 120 to lower the travel speed of the unmanned self-driving vehicles 28. This lowers an upper limit of the travel speed of the unmanned self-driving vehicles 28, enabling any detriment to safety to be suppressed from occurring.

After control to lengthen the communication cycle of the wireless communication with the unmanned self-driving vehicles 28 and processing to lower the travel speed of the unmanned self-driving vehicles 28 has been performed at step 120, 1 is assigned to the flag F3 at the next step 122 and processing returns to step 104.

As described above, in the first exemplary embodiment, in cases in which the wireless communication traffic volume T has exceeded the predetermined and predefined communication traffic volume Ts, processing split into three separate stages may be performed. This enables the respective processing to be performed in sequence from the processing that has the least impact.

### Second Exemplary Embodiment

Next, explanation follows regarding a second exemplary embodiment.

A vehicle self-driving system 10 of the second exemplary embodiment has a similar basic hardware configuration as that of the first exemplary embodiment.

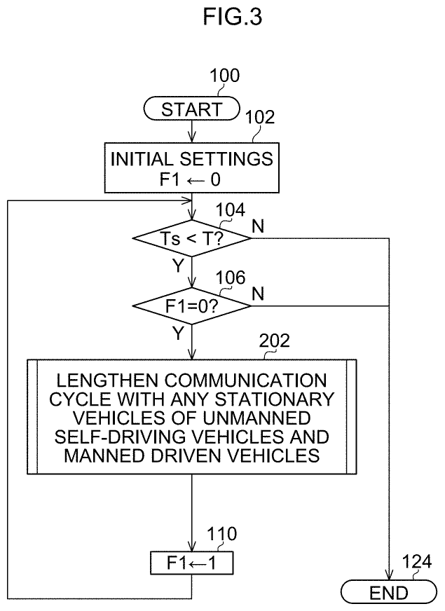

As illustrated in FIG. 3, in the second exemplary embodiment, processing is performed in a single stage in cases in which the wireless communication traffic volume T has exceeded the predetermined and predefined communication traffic volume Ts. As illustrated by step 202 in FIG. 3, processing is performed in the second exemplary embodiment to lengthen a communication cycle with any stationary vehicles of all the unmanned self-driving vehicles 28 within the predefined area and all the manned driven vehicles 30 within the predefined area that have handed over driving authority. Namely, there is a low risk of stationary vehicles causing an accident prior to resuming travel, regardless of whether they are the unmanned self-driving vehicles 28 or the manned driven vehicles 30. Accordingly, lengthening the communication cycle with stationary vehicles at step 202 enables a commensurate re-allocation to wireless communication with an additional unmanned self-driving vehicle 28 and/or manned driven vehicle 30, thereby enabling the wireless communication to be secured with the unmanned self-driving vehicle 28 and/or manned driven vehicle 30.

Note that the processing at step 202 to lengthen the communication cycle with stationary vehicles of all the unmanned self-driving vehicles 28 within the predefined area and all the manned driven vehicles 30 within the predefined area that have handed over driving authority is an example of processing to reduce the wireless communication information volume of at least one type of vehicle of unmanned self-driving vehicles 28 or manned driven vehicles 30. Other conceivable implementations of such processing include processing to reduce the wireless communication information volume of any stationary vehicles of all the unmanned self-driving vehicles 28 within the predefined area and all the manned driven vehicles 30 within the predefined area that have handed over driving authority.

In the first exemplary embodiment, processing split into three separate stages is performed in cases in which the wireless communication traffic volume T has exceeded the predetermined and predefined communication traffic volume Ts. However, the configuration is not limited to this, and the processing may have a single stage, two stages, or four or more stages.

In the first exemplary embodiment, control is performed to lower the travel speed of the unmanned self-driving vehicles 28 in cases in which the wireless communication traffic volume T has exceeded the predetermined and predefined communication traffic volume Ts. However, the configuration is not limited to this, and the travel speed of the manned driven vehicles 30 may be lowered, or the travel speeds of both the unmanned self-driving vehicles 28 and the manned driven vehicles 30 may be lowered, in cases in which the wireless communication traffic volume T has exceeded the predetermined and predefined communication traffic volume Ts.

What is claimed is:

1. A vehicle self-driving system, comprising:
a communication section provided separately from both an unmanned self-driving vehicle configured to travel unmanned within a predefined area and a manned driven vehicle that has entered the predefined area and has completed a handover of driving authority, the communication section being configured to perform two-way wireless communication with both the unmanned self-driving vehicle and the manned driven vehicle; and
a control section configured to be handed driving authority from the manned driven vehicle by the wireless communication and to control respective movements of the unmanned self-driving vehicle and the manned driven vehicle based on the wireless communication, and further configured to effect control such that a communication cycle of the wireless communication with at least one of the unmanned self-driving vehicle or the manned driven vehicle is lengthened in a case in which a communication traffic volume of the wireless communication has exceeded a predefined value.

2. A vehicle self-driving system, comprising:
a communication section provided separately from both an unmanned self-driving vehicle configured to travel unmanned within a predefined area and a manned driven vehicle that has entered the predefined area and has completed a handover of driving authority, the communication section being configured to perform two-way wireless communication with both the unmanned self-driving vehicle and the manned driven vehicle; and
a control section configured to be handed driving authority from the manned driven vehicle by the wireless communication and to control respective movements of the unmanned self-driving vehicle and the manned driven vehicle based on the wireless communication, and further configured to interrupt the wireless communication with the manned driven vehicle in a case in which a communication traffic volume of the wireless communication has exceeded a predefined value.

3. A vehicle self-driving system, comprising:
a communication section provided separately from both an unmanned self-driving vehicle configured to travel unmanned within a predefined area and a manned driven vehicle that has entered the predefined area and has completed a handover of driving authority, the communication section being configured to perform two-way wireless communication with both the unmanned self-driving vehicle and the manned driven vehicle; and
a control section configured to be handed driving authority from the manned driven vehicle by the wireless communication and to control respective movements of the unmanned self-driving vehicle and the manned driven vehicle based on the wireless communication, and further configured to reduce a volume of information received via the wireless communication of at least one of the unmanned self-driving vehicle or the manned driven vehicle in a case in which a communication traffic volume of the wireless communication has exceeded a predefined value.

4. The vehicle self-driving system of claim 1, wherein the control section is configured to effect control so as to lower a travel speed of at least one of the manned driven vehicle or the unmanned self-driving vehicle in a case in which a communication traffic volume of the wireless communication has exceeded a predefined value.

5. An operation method for a vehicle self-driving system including an unmanned self-driving vehicle configured to travel unmanned within a predefined area, a manned driven vehicle that has entered the predefined area and has handed over driving authority, and a communication section configured to perform two-way wireless communication with both the unmanned self-driving vehicle and the manned driven vehicle, the operation method comprising:
controlling respective movements of the unmanned self-driving vehicle and the manned driven vehicle based on the wireless communication after the driving authority has been handed over from the manned driven vehicle to the system by the wireless communication; and
in a case in which a communication traffic volume of the wireless communication has exceeded a predefined value, performing at least one of:
(a) effecting control so as to lengthen a communication cycle of the wireless communication with at least one of the unmanned self-driving vehicle or the manned driven vehicle, or
(b) interrupting the wireless communication with the manned driven vehicle.

6. An operation method for a vehicle self-driving system including an unmanned self-driving vehicle configured to travel unmanned within a predefined area, a manned driven vehicle that has entered the predefined area and has handed over driving authority, and a communication section configured to perform two-way wireless communication with both the unmanned self-driving vehicle and the manned driven vehicle, the operation method comprising:
controlling respective movements of the unmanned self-driving vehicle and the manned driven vehicle based on the wireless communication after the driving authority has been handed over from the manned driven vehicle to the system by the wireless communication; and
reducing a volume of information received via the wireless communication of at least one of the unmanned self-driving vehicle or the manned driven vehicle in a case in which a communication traffic volume of the wireless communication has exceeded a predefined value.

7. A non-transitory storage medium storing a program executable by a computer to perform control processing for a vehicle self-driving system including an unmanned self-driving vehicle configured to travel unmanned within a predefined area, a manned driven vehicle that has entered the predefined area and has handed over driving authority, and a communication section configured to perform two-way wireless communication with both the unmanned self-driving vehicle and the manned driven vehicle, the control processing comprising:
controlling respective movements of the unmanned self-driving vehicle and the manned driven vehicle based on the wireless communication after the driving authority has been handed over from the manned driven vehicle to the system by the wireless communication; and
in a case in which a communication traffic volume of the wireless communication has exceeded a predefined value, performing at least one of:
(a) effecting control so as to lengthen a communication cycle of the wireless communication with at least one of the unmanned self-driving vehicle or the manned driven vehicle, or
(b) interrupting the wireless communication with the manned driven vehicle.

8. A non-transitory storage medium storing a program executable by a computer to perform control processing for a vehicle self-driving system including an unmanned self-driving vehicle configured to travel unmanned within a predefined area, a manned driven vehicle that has entered the predefined area and has handed over driving authority, and a communication section configured to perform two-way wireless communication with both the unmanned self-driving vehicle and the manned driven vehicle, the control processing comprising:
controlling respective movements of the unmanned self-driving vehicle and the manned driven vehicle based on the wireless communication after the driving authority has been handed over from the manned driven vehicle to the system by the wireless communication; and
reducing a volume of information received via the wireless communication of at least one of the unmanned self-driving vehicle or the manned driven vehicle in a case in which a communication traffic volume of the wireless communication has exceeded a predefined value.
